(19) United States
(12) Patent Application Publication
(10) Pub. No.: US 2014/0255588 A1
(43) Pub. Date: Sep. 11, 2014

(54) METHOD FOR PRODUCING REDUCED-FAT FOODS SUCH AS MEAT PRODUCTS AND SAUSAGE PRODUCTS

(71) Applicants: Fritz Kortschack, Berlin (DE); Volker Heinz, Quakenbrück (DE); Bajo Bajovic, Osnabruck (DE)

(72) Inventors: Fritz Kortschack, Berlin (DE); Volker Heinz, Quakenbrück (DE); Bajo Bajovic, Osnabruck (DE)

(73) Assignee: DIL German Institute of Food Technologies, Quakenbrück (DE)

(21) Appl. No.: 14/350,733

(22) PCT Filed: Sep. 28, 2012
(86) PCT No.: PCT/EP2012/069189

§ 371 Date: Apr. 9, 2014

(30) Foreign Application Priority Data
Oct. 10, 2011 (DE) 10 2011 115 565.5
Jun. 18, 2012 (DE) 10-2012-012-091.5
Jul. 6, 2012 (DE) 10 2012 106 092.4

(51) Int. Cl. A23L 1/317; A23J 3/00; A23J 3/14; A23L 1/315

(52) U.S. Cl. CPC A23L 1/3175; A23L 1/3152; A23J 3/04; A23J 3/14
USPC 426/644; 426/646; 426/656; 426/443

(57) ABSTRACT

The invention relates to a method for producing reduced-fat foods such as meat products and sausage products, in particular raw, cooked, or boiled sausages, on the basis of a sausage meat made from a ground amount of meat, optionally a water addition, and the addition of salt, spices, auxiliary substances, and additives. According to the invention, animal tissue, in particular lean meat, treated with high pressure and/or skin treated with high pressure is fed to the mixture cut to produce the sausage meat as an at least partial fat substitute, whereby the protein content of the mixture is increased and the structure of the product is appealing and not similar to reduced-fat products.

The invention relates to a method for the production of fat-reduced meat and sausage products, in particular raw, cooked or scalded sausages, on the basis of a sausage meat made from a minced amount of meat, if necessary added water, and the addition of salt, spices, auxiliary substances and additives according to patent claim 1.

In connection with changed nutritional aspects there is a still unmet demand for sausage products, e.g. raw sausages, scalded sausages, cooked sausages or cooked sausage spreads, that not only have a good taste and provide a pleasant mouthfeel, but have at the same time a fat content as low as possible.

Known scalded sausages contain, for instance, approximately 50% of meat, 25% of fat and 25% of water. On the production side bacon and meat are first pre-chopped and then minced in a bowl cutter to obtain the so-called sausage meat. A bowl cutter is a vessel in which a knife assembly rotates at high speed. The rotation of the knives results in a comminution of the ingredients until the sausage meat has a pasty consistency. The salt-soluble proteins are dissolved in the bowl cutter by the addition of cooking salt and/or nitrite curing salt. The addition of cooking salt or nitrite curing salt not only results in the dissolution of the proteins, but also achieves a preserving effect. Thus, it is the aim to dissolve as much fibrillar muscle protein as possible during the bowl cutting.

The subsequent thermal treatment denaturates the dissolved fibrillar muscle protein and thus provides for the desired sliceability of the end product, if cooked products such as scalded or cooked sausage are concerned.

In the production of scalded sausages a sausage meat is obtained by adding, in the classical way, fat into the bowl cutter. In the production of scalded sausages the fat not only acts as a flavor carrier, but is also significant for the texture. Fat-reduced sausages available on the market contain, in many cases, poultry meat or meat with a low content of fat from different body parts of beef or pork. Such known products appear to be dry, however, break easily, are often characterized by a rubber-like consistency and do not have the fresh typical taste of sausage. Additions of vegetable oils, or the complete substitution of the fat by fat substitutes based on vegetable oil did not bring about any substantially positive results in view of the aforementioned disadvantages.

A method for the production of a fat-reduced scalded sausage is known from DE 101 06 553 B4. The focus of the production is on an optimized bowl cutting process. Initially, a substantially fat-free amount of meat is minced without the addition of fat. This minced mass of meat is then cooled. A major portion of the minced, cooled total mass of meat is then cut in the bowl cutter and further cooled by adding ice, with the addition of spices, nitrite curing salt or the like. The remaining portion of the total amount of meat is added to the minced mass in a slightly frozen state. With the addition of cooled water the bowl cutting is then continued until a sausage meat mass having a temperature of approximately 13° to 15° is obtained. The sausage meat mass can then be filled into artificial casings to form sausages, followed by cooking or scalding.

The production of a cooked spreadable liver sausage and of a raw sausage is known from DE 10 2005 010 836 A1 and DE 10 2005 026 752 A1 . In the first case the spreadable liver sausage contains muscle meat and liver, with a maximum fat content of 4% in the muscle meat. Except for the fat contained in the muscle meat portion no additional fat is added. In the production of raw sausage it is equally assumed that the fat content in the muscle meat amounts to a maximum of 4% and that no additional fat is added. The muscle meat may contain pork and/or beef.

In the sausage-like food product consisting of meat, vegetables and lupine protein according to DE 101 28 288 A1, too, no fat, bacon or oil are added. The meat protein is replaced by lupine protein, so that a product with only a small animal food portion is obtained.

In the method for the production of a meat product, in particular a scalded sausage, according to EP 0 990 394 B1 the fat content of the ready-to-use product is less than 0.5 by weight. To obtain such a product, a mass of raw meat with 50 to 80 parts by weight of a lean meat mass, 15 to 35 parts by weight of water, 3 to 7 parts by weight of dietary fibers, 1 to 2 parts by weight of curing salt, 1 to 5 parts by weight of common ingredients are assumed, the lean meat mass consisting of 50 to 100% by weight of lean meat and 0 to 5% by weight of protein mass. This mixture is bowl-cut and mixed with 0.05 to 0.2 parts by weight of transaminase, mixed thoroughly and heated over a period of up to 2 hours, and then packaged to obtain a ready-to-use product.

Based on the prior art described it can, thus, be concluded that there are different possibilities to substitute fat or reduce fat. To ensure the sensory quality of the product if substantially fat-free meat is used the fat is replaced by the use of fat emulsions oil-in-water, or fibers and thickening agents are added. Especially raw sausage products available on the market with a reduced fat content only have an insufficient sensory quality. Moreover, the products available on the market only have a minimum fat content of approximately 15%. Products having a fat content of less than 10% are not available on the market at least until now. Existing products have a sandy consistency and rubber-like texture, along with an unpleasant mouthfeel and eating sensation.

Based on the foregoing it is the object of the invention to provide a further developed method for the production of fat-reduced meat and sausage products, in particular raw, cooked or scalded sausages, which allows to produce a product which is very pleasant in sensory terms and in terms of mouthfeel, which is furthermore nutritionally uncritical and can be produced with little expenditure and at acceptable cost.

The solution to the object of the invention is achieved by a method as taught in patent claim 1. Claims 9 to 12 relate to end products according to the invention.

Accordingly, there is proposed a method for the production of fat-reduced meat and sausage products, in particular raw, cooked or scalded sausages, on the basis of a sausage meat made from a minced amount of meat, if necessary added water, and the addition of salt, spices, auxiliary substances and additives.

According to the invention a portion of high-pressure treated animal tissue, in particular lean meat and/or high-pressure treated skin and/or high-pressure treated vegetable protein is added as an at least partial fat substitute to the mixture bowl-cut to sausage meat. By choosing the parameters (pressure, time, temperature) and the portion of high-pressure treated raw material it is possible to selectively control the texture of the end product. This addition furthermore increases the protein content in the mixture, and a very appealing structure of the product is obtained which is similar to those goods that are not fat-reduced.

In addition to using it as a fat substitute it is possible to selectively reduce the pH-value of the raw material by adding nitrite curing salt and/or cooking salt and/or by the addition of starter cultures and/or GDL. The subsequent mechanical loading or treatment with hydrostatic high pressure allows an accelerated water withdrawal and drying. The so obtained raw material can be used for the further production, for instance, of meat products.

The high-pressure treatment of the amount of lean meat serving as fat substitute, e.g. animal tissue with a small fat content, is carried out until the protein denaturates and the product becomes lighter.

In one embodiment of the invention a mixture consisting of a high-pressure treated mixture of poultry fat and/or poultry skin as well as lean meat is added to the sausage meat.

The lean meat used may be pretreated hydrolytically, enzymatically, chemically and/or physically in a known manner prior to the high-pressure treatment.

In another embodiment of the invention the bowl-cut sausage meat is subjected to a separate high-pressure treatment to reduce the use of salt and to bring out the taste of added spices.

To obtain a desired disintegration the possibly pre-chopped meat amount may be cooled prior to introducing it into the bowl cutter.

With reference to the above explanations the method is characterized in that the mixture bowl-cut to sausage meat is largely free from vegetable fats or oils or oil-based fat substitute components.

According to a preferred embodiment the high-pressure treatment is carried out in a pressure range of approximately 50 MPa to 600 MPa or more over a period of up to several minutes.

Furthermore, sausage products produced according to the method explained are in accordance with the invention.

Related to the total amount of meat the portion of high-pressure treated lean meat may be 10 to 50% by weight. The lean meat, which has become lighter by the high-pressure treatment, is then provided in the sausage meat in the form of pieces so that a lumpiness is obtained which is similar to the one produced by the addition of bacon. Thus, the function of the previously common addition of bacon and fat as well as the desired appearance and the resulting firmness to the bite during consumption remain preserved.

It has shown that on the basis of introduced known recipes the fat added there can be readily replaced by the lean meat high-pressure treated in accordance with the invention. This leads to the advantage that the protein portion in the meat and sausage products is increased. Eventually, it is possible to produce fat-reduced raw sausages with fat contents<10% the appearance and cutting surface of which correspond to the usual standard.

The production of pure poultry products is possible, too, in which the fat content is replaced by high-pressure treated poultry meat or high-pressure treated poultry meat emulsions. The previously known use of non-poultry fat in such poultry products can thus be precluded.

Eventually, the addition of fibers and other ingredients such as inulin or thickening agents can largely be waived.

1. A method for the production of fat-reduced foodstuffs such as meat and sausage products, in particular raw, cooked or scalded sausages, the method comprising:
providing a sausage meat made from a minced amount of meat, if necessary added water, and the addition of salt, spices, auxiliary substances and additives; and
adding high-pressure treated animal tissue, in particular lean meat and/or high-pressure treated skin and/or high-pressure treated vegetable protein as an at least partial fat substitute to the mixture bowl-cut to sausage meat, whereby the protein content in the mixture increases and the structure of the product is appealing and not similar to fat-reduced products.

2. The method of claim 1, wherein,
the high-pressure treatment of lean meat is carried out until the protein denaturates and the product becomes lighter.

3. The method of claim 1, wherein,
a mixture consisting of a high-pressure treated mixture of poultry fat and/or poultry skin as well as lean meat is added to the sausage meat.

4. The method of claim 1, wherein,
the lean meat is pretreated hydrolytically, enzymatically, chemically and/or physically prior to the high-pressure treatment.

5. The method of claim 1, wherein,
the bowl-cut sausage meat is subjected to a separate high-pressure treatment to reduce the use of salt.

6. The method of claim 1, wherein,
the amount of meat treated with hydrostatic pressure is cooled/frozen prior to introducing it into the bowl cutter.

7. The method of claim 1, wherein,
the mixture bowl-cut to sausage meat is largely free from vegetable fats or oils or oil-based fat substitute components.

8. The method of claim 1, wherein,
the high-pressure treatment is carried out in a pressure range of at least approximately 50 MPa to 600 MPa or more over a period of up to several minutes.

9. A method of producing foodstuffs, the method comprising:
providing raw material acidified by starter cultures and/or GDL with the addition of nitrite curing salt and/or cooking salt;
subjecting the raw material to hydrostatic high pressure and/or a mechanical load for the accelerated water withdrawal; and
wherein the obtained raw material can be used for the further production, for instance, of meat products.

10. A sausage product, produced according to the method of claim 9.

11. A snack in a geometrically designed form having a high protein content of animal or vegetable origin, produced according to the method of claim 9.

12. A snack according to claim 11 in a bar, stick, coil or similar shape.
